(19) United States
(12) Patent Application Publication
(10) Pub. No.: US 2026/0290084 A1
(43) Pub. Date: Sep. 24, 2026

(54) VEHICLE STRUCTURAL SENSOR AND SYSTEM

(71) Applicant: Shape Corp., Grand Haven, MI (US)

(72) Inventors: Tyler WILLIAMS, Grand Haven, MI (US); Joseph R. MATECKI, Allendale, MI (US)

(73) Assignee: Shape Corp., Grand Haven, MI (US)

(21) Appl. No.: 19/573,510

(22) Filed: Mar. 20, 2026

Related U.S. Application Data
(60) Provisional application No. 63/774,956, filed on Mar. 20, 2025.

(51) Int. Cl. G07C 5/02; B60R 16/02; B60R 19/48; B62D 21/17; B62D 25/02; G01D 5/16

(52) U.S. Cl. CPC G07C 5/02; B60R 16/0215; B60R 19/483; B62D 21/17; B62D 25/025; G01D 5/16

(57) ABSTRACT

A vehicle structural sensor is provided for detecting and recording deformation of a vehicle structural component resulting from an external impact force. The sensor includes a reinforcement beam having an inboard wall section and an outboard wall section configured to deform inward upon receiving an external impact force, and a flexible non-conductive substrate supporting a plurality of conductors attached to an interior surface of the beam. Each conductor forms a protrusion spaced from an opposing interior surface of the beam at a set distance configured to cause electrical contact with a conductive portion of the beam when the outboard wall section deforms inward under the impact force. The degree and location of deformation are determined from the electrical contact pattern. A vehicle structure monitoring system includes a controller configured to receive deformation signals from the sensor and generate notifications when a structural condition value exceeds a threshold.

### CROSS-REFERENCE TO RELATED APPLICATION

This application claims the benefit and priority under 35 U.S.C. §119(e) of U.S. provisional application Ser. No. 63/774,956, filed on Mar. 20, 2025, the content of which is incorporated herein by reference in its entirety.

### TECHNICAL FIELD

The present disclosure relates to structural sensors and systems for monitoring the structural condition of a vehicle, and more specifically to a vehicle structural sensor configured to monitor deformation imparted by an external force, such as a result of an impact or collision, and to provide structural health data for the vehicle over time.

### BACKGROUND

Vehicle frames and body structures are designed to support a vehicle and to absorb certain levels of impact forces, so as to prevent inboard intrusion into the vehicle and protect occupants in accordance with insurance requirements and other regulatory and legal requirements. The structural components and assemblies designed to manage vehicle impact energy are primarily concealed by facia and body panels that provide the exterior appearance of the vehicle. When a vehicle undergoes an impact or collision, structural damage is typically assessed, at least initially, by external visual inspection to estimate the potential damage resulting from the incident.

While visual inspections can effectively diagnose significant damage that is evident at the facia and body panels, damage resulting from lower speed or lower mass impacts can be difficult to detect visually. Conventional sensor approaches, such as accelerometers and field-of-view sensors, can indicate the occurrence of an impact event but generally do not provide persistent, location-specific structural deformation data or historic structural health records following an impact event. The continued operation of a vehicle with a damaged frame or component can lead to an increased risk that future collisions or impacts will not be managed to the designed level of performance and impact energy management. Vehicle owners, operators, and occupants, repair technicians, vehicle purchasers, and insurance companies, among others, would benefit from understanding whether a vehicle structural component or related assembly is damaged, the location and extent of the damage, and whether the damage poses a risk to continued operation of the vehicle.

### SUMMARY

The present disclosure provides a structural sensor for a vehicle structure monitoring system used to monitor a vehicle structure for collision damage. The structural sensor may be disposed at one or more locations and incorporated with one or more structural assemblies of the vehicle, such that the corresponding vehicle structure can be monitored and collision damage can be sensed and tracked over time to provide structural health data for a vehicle. For example, by using the structural sensor, the system can monitor and historically track structural-level data and individual component-level data.

According to an aspect of the disclosure, a vehicle structural sensor is provided with a reinforcement beam having an inboard wall section and an outboard wall section configured to deform inward toward the inboard wall section upon receiving an external impact force. The reinforcement beam has a conductive portion, such as on an interior surface of the inboard wall section or the outboard wall section. The vehicle structural sensor also includes a flexible non-conductive substrate attached to an interior surface of the inboard or outboard wall section of the reinforcement beam. A plurality of conductors is electrically connected together and supported by the flexible non-conductive substrate. The conductors may each form a protrusion that extends away from the flexible non-conductive substrate toward the opposing interior surface of the inboard or outboard wall section. End portions of the protrusions are spaced from the opposing interior surface at a set distance that is configured to cause electrical contact with the conductive portion when the outboard wall section deforms inward under the external impact force.

In some implementations, a resistor is electrically connected in series between each adjacent pair of the plurality of conductors, such that a resistance value sensed across the plurality of conductors corresponds to a location of electrical contact along a length of the reinforcement beam. For instance, a system receiving signals from the vehicle structural sensor may be configured to compare the sensed resistance in order to determine the location of the impact and the corresponding electrical contact along the length of the reinforcement beam.

In some examples, the plurality of conductors includes a first conductor extending from the flexible non-conductive substrate a first distance and a second conductor extending from the flexible non-conductive substrate a second distance greater than the first distance. The first and second distances, in some implementations, are configured such that electrical contact at the first conductor indicates a first depth of inward deformation of the outboard wall section and electrical contact at the second conductor indicates a second, greater depth of inward deformation corresponding to a greater magnitude of external impact force. Further, in some examples, the plurality of conductors are divided into a plurality of sensor zones spaced along the length of the reinforcement beam, with each of the plurality of zones having conductors extending at least two different distances from the flexible non-conductive substrate to be configured to determine a corresponding intrusion distance and a location of the impact along the reinforcement beam.

In some implementations, the flexible non-conductive substrate includes a bendable, non-electrically conductive material, such as a polyimide, polyester, glass, rubber, or polymer composite or other materials or composites thereof. In some examples, the flexible non-conductive substrate may include a thin, flexible polymer strip configured to be unrolled from a coil into the reinforcement beam, such as during a roll forming operation. In some examples, the flexible non-conductive substrate includes a molded polymer strip.

The reinforcement beam, in some implementations, has an elongated hollow body having the inboard and outboard wall sections extending between opposing ends of the reinforcement beam. In some examples, the plurality of conductors may be disposed along an intermediate section of the elongated hollow body between the opposing ends. Also, in some examples, the flexible non-conductive substrate is disposed along an interior surface of the elongated hollow body.

In some implementations, the reinforcement beam has an elongated hollow body that includes a pair of tubular portions extending between the opposing ends of the reinforcement beam. In some examples, the elongated hollow body is formed from a metal sheet having a seam defined by an edge section of the metal sheet attached along an intermediate section of the metal sheet. In various implementations, the elongated hollow beam is a bumper beam, a frame component, a door beam, or a rocker component.

According to another aspect of the disclosure, a vehicle structural sensor includes a reinforcement beam having an elongated hollow body with a first wall section and a second wall section extending between opposing ends of the reinforcement beam. The second wall section is configured to deform toward the first wall section upon receiving an impact force. A conductor module is disposed within a hollow interior of the reinforcement beam. The conductor module includes a flexible non-conductive substrate that is disposed along an interior surface of the inboard wall section. A plurality of conductors are supported by the flexible non-conductive substrate, where the conductors each form a protrusion that extends away from the flexible non-conductive substrate toward a conductive portion disposed at or integrated with an interior surface of the outboard wall section. The protrusions are spaced from the conductive portion at a set distance that is configured to cause electrical contact with the conductive portion when the outboard wall section deforms inward under the impact force.

In some implementations, a secondary substrate is disposed opposite the substrate along the interior surface of the outboard wall section, and the secondary substrate may have the conductive portion on an interior surface thereof. For example, the conductive portion may include a metal strip attached along a length of the interior surface of the secondary substrate. In other examples, the reinforcement beam includes the conductive portion that contacts the protrusions of the plurality of conductors. In additional examples, a plurality of non-conductive stanchions are provided that separate the substrate from the secondary substrate at a fixed separation distance.

According to a further aspect of the disclosure, a conductor module is provided for insertion into a reinforcement beam. The conductor module includes a flexible non-conductive primary substrate and a secondary substrate disposed opposite the primary substrate and having a conductive portion on an interior surface thereof. A plurality of conductors are supported by the primary substrate, each conductor forming a protrusion extending toward the conductive portion of the secondary substrate. The protrusions are spaced from the conductive portion at a set distance configured to cause electrical contact when the reinforcement beam deforms inward under an impact force. In some implementations, the protrusions each comprise a metal strip formed in a series of alternating bends defining a stacked zigzag spring structure. The conductor module may be inserted into a formed reinforcement beam or may be assembled into the beam during formation.

According to yet a further aspect of the disclosure, the vehicle structural sensor may be embodied as a front rail of a vehicle frame. A plurality of conductors are cantilevered from an interior side wall of the front rail and are spaced from an opposing interior surface at a set distance configured to cause electrical contact when the front rail deforms and bends under an axial impact force. The sequential contact of the conductors with the opposing interior surface is configured to indicate the progression and location of deformation along the length of the front rail.

According to a further aspect of the disclosure, a vehicle structural monitoring system includes a vehicle structural sensor, such as described above, and a controller in electrical communication with the vehicle structural sensor. The controller is configured to receive a local deformation signal from at least one of the plurality of deformation conductors above a threshold that corresponds to a degree of inward deformation to the reinforcement beam. The controller is further configured to determine a structure condition value based on the local deformation signal, and to determine whether the structure condition value exceeds a threshold condition value. A notification is generated when the structure condition value exceeds the threshold condition value.

In some implementations, the threshold condition value includes at least one of a repair threshold or an occupant safety threshold. Also, in some examples, the notification is transmitted to at least one of a vehicle display, a memory unit onboard the vehicle, or a remote receiver via a transceiver. The controller may further be configured to receive a collision signal from an auxiliary vehicle sensor indicating that an impact with an object has occurred, and in response to the collision signal, receive the local deformation signal from the vehicle structural sensor to confirm or validate the detected collision.

According to yet another aspect of the disclosure, a method for monitoring a vehicle structure for collision damage includes providing a vehicle structural sensor, such as described above. A local deformation signal is received at a controller from at least one of the plurality of conductors of the vehicle structural sensor. The method includes determining that the local deformation signal exceeds a threshold change that indicates a degree of deformation to the respective vehicle structural components. A structure condition value is generated based on the local deformation signal that corresponds to the degree of deformation.

Implementations of the disclosure may include one or more of the preceding features in various combinations.

### BRIEF DESCRIPTION OF THE DRAWINGS

FIG. 1 is a perspective view of a vehicle showing a bumper assembly and other concealed structural components.

FIG. 2 is a perspective view of a vehicle structural sensor integrated with a front bumper assembly.

FIG. 3 is a cross-sectional view of the front bumper assembly and the vehicle structural sensor taken at line III-III shown in FIG. 2.

FIG. 4 is a schematic top view of a vehicle structural sensor.

FIG. 5 is a schematic top view of the vehicle structural sensor shown in FIG. 4 undergoing an impact force.

FIG. 6 is a schematic perspective view of a section of a flexible non-conductive substrate supporting conductors of the vehicle structural sensor shown in FIG. 4.

FIG. 7 is a schematic side view of the flexible non-conductive substrate and the supported conductors shown in FIG. 6.

FIG. 8 is a schematic side view of the flexible non-conductive substrate and conductors feeding into a roll former forming a reinforcement beam.

FIG. 9 is a top view of a flexible non-conductive substrate supporting conductors.

FIG. 10 is a perspective view of the flexible non-conductive substrate and conductors shown in FIG. 9.

FIG. 11 is a perspective view of a vehicle structural sensor.

FIG. 12 is a perspective view of a conductor module of the vehicle structural sensor shown in FIG. 11.

FIG. 13 is a perspective view of the vehicle structural sensor of FIG. 11 deformed inward from an impact force.

FIG. 14 is a cross-sectional top view of an additional vehicle structural sensor.

FIG. 15 is an enlarged view of the vehicle structural sensor taken at section XV shown in FIG. 14.

FIG. 16 is a perspective view of a conductor module having a flexible non-conductive substrate supporting conductors.

FIG. 17 is an enlarged perspective view of the conductor module shown at section XVII of FIG. 16.

FIG. 18 is a graphical illustration of output from the vehicle structural sensor with the conductor module shown in FIG. 16.

FIG. 19 is a perspective view of a reinforcement beam with a conductor module.

FIG. 20 is an end view of the reinforcement beam of FIG. 19, showing the conductor module therein.

FIG. 21 is a perspective view of the conductor module shown in FIG. 20.

FIG. 22 is a cross-sectional view of the conductor module of FIG. 21.

FIG. 23 is a graphical illustration of the impact force received at the vehicle structural sensor shown in FIG. 19.

FIG. 24 is a graphical illustration of the sensor signal during the impact force received at the vehicle structural sensor shown in FIG. 19.

FIG. 25 is a schematic top view of a front rail bent after undergoing front impact.

FIG. 26 is a schematic top view of a vehicle structural sensor integrated as a front rail.

FIG. 27 is a schematic top view of another example of a vehicle structural sensor integrated as a front rail.

FIG. 28 is a schematic top view of a front rail with the vehicle structural sensor.

FIG. 29 is a schematic top view of the vehicle structural sensor shown in FIG. 28 partially deformed when undergoing a front impact.

FIG. 30 is a schematic top view of the vehicle structural sensor shown in FIG. 28 further deformed when undergoing a front impact.

FIG. 31 is a schematic view of a vehicle having a vehicle structural sensor and system configured to monitor the corresponding vehicle structure for collision damage.

FIG. 32 is a schematic view of a controller for the vehicle structure monitoring system.

The details of one or more examples of the disclosure are set forth in the accompanying drawings and the description below. Other aspects, advantages, purposes, and features will be apparent upon review of the following specification in conjunction with the drawings, where like reference numerals indicate like parts.

### DETAILED DESCRIPTION

Vehicle structural frames and assemblies and components thereof are disclosed herein in various implementations as impact energy absorption and management devices that are used in conjunction with other vehicle components to absorb and manage impact loads and energy, so as to structurally support the vehicle and its contents during operation and minimize damage and intrusion during an impact to the vehicle. Vehicle structural components, such as bumper assemblies and rocker structures, are typically concealed by vehicle body panels and facia. A vehicle structure monitoring system may be provided for monitoring the vehicle structure for collision damage without requiring visual inspection or removal of body panels or facia. The system may employ one or more vehicle structural sensors, such that the vehicle structure can be monitored and collision damage can be sensed and tracked over time to provide structural health data for a vehicle.

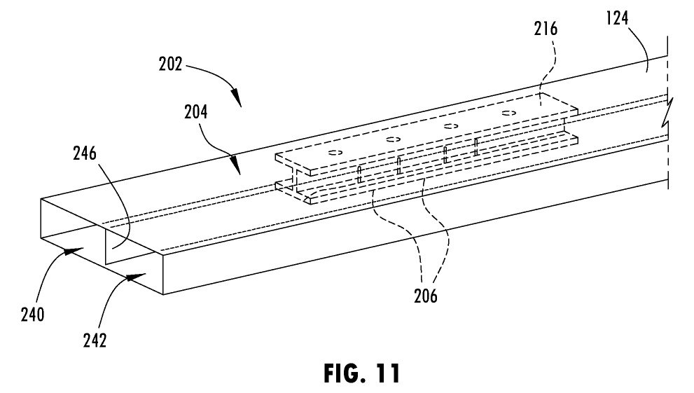

Referring now to the drawings and the illustrative embodiments depicted therein, a vehicle structure monitoring system 100 includes at least one vehicle structural sensor 102 that has a reinforcement beam 104 and a set of conductors 106 disposed along the reinforcement beam 104. The conductors 106 are configured to make electrical contact with a conductive portion 108 of the reinforcement beam 104 upon receiving an impact force to the vehicle 110 that deforms the reinforcement beam 104 a threshold distance of intrusion. The conductive portion 108 may be an integral portion of a metal structure of the beam 104 or may be a separate portion that is formed with or disposed adjacent to the structure of the beam 104. The reinforcement beam 104 has at least an inboard wall section 112 and an outboard wall section 114, where the outboard wall section 114 is configured to deform inward toward the inboard wall section 112 upon receiving an external impact force. The vehicle structural sensor 102 also includes a flexible non-conductive substrate 116 attached to the inboard wall section 112 or the outboard wall section 114 of the reinforcement beam 104. The conductors 106 are electrically connected together and supported by the flexible non-conductive substrate 116. In some examples, the flexible non-conductive substrate 116 and the supported conductors 106 may be assembled as a conductor module (FIGS. 11-22), such as to provide a conductive portion 108 therein. When installed in the beam 104, the conductors each form a protrusion 118 that extends away from the flexible non-conductive substrate 116 toward the opposing wall section of the reinforcement beam 104. End portions of the protrusions 118 are spaced from the opposing wall section in a manner that is configured to cause electrical contact with the conductive portion 108 of the reinforcement beam 104 when the outboard wall section 114 deforms inward under the external impact force to the vehicle 110.

As used herein, the term “conductive portion” refers to any electrically conductive element, whether integral to the structure of the reinforcement beam or separately attached thereto, that is positioned to make electrical contact with the end portion of a protrusion upon deformation of the reinforcement beam. The term “protrusion” refers to a conductor element that extends from the flexible non-conductive substrate into the hollow interior of the reinforcement beam toward an opposing surface.

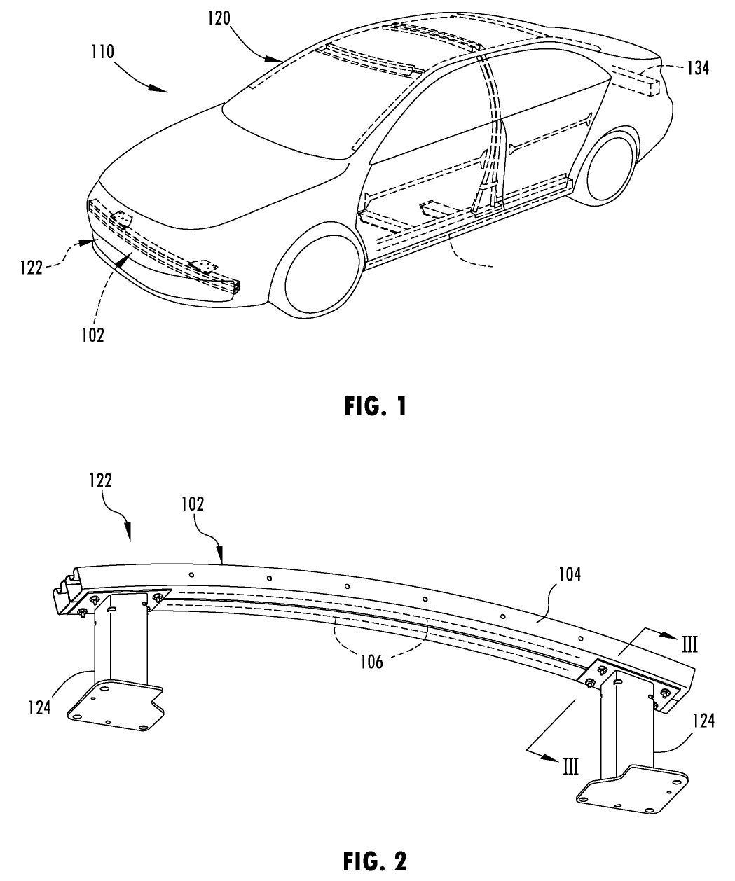

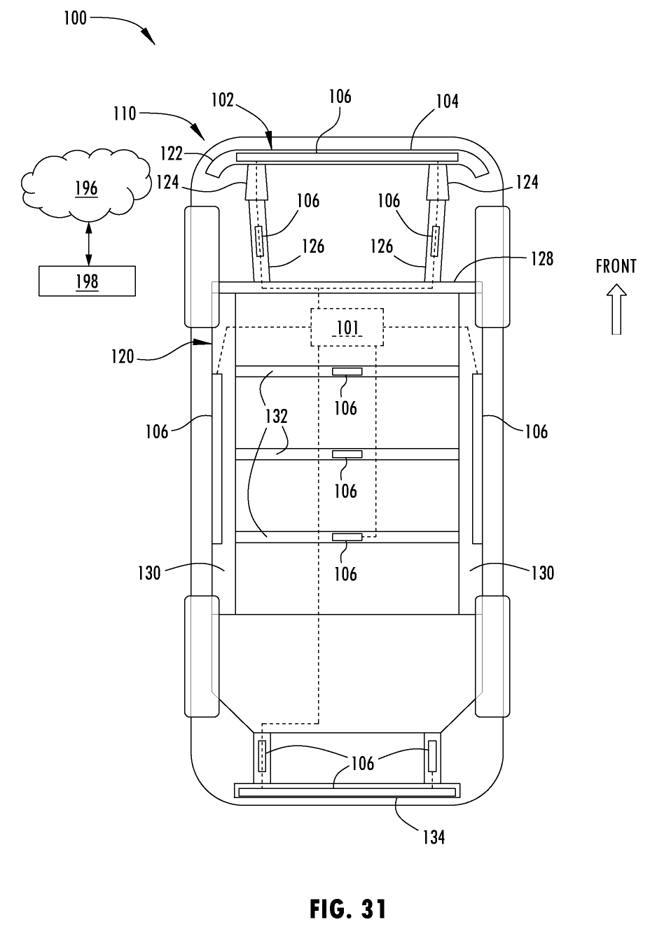

As shown in FIG. 1, the vehicle 110 having the vehicle structural sensor 102 and corresponding monitoring system 100 (FIG. 31) includes a structural frame 120 having various structural components and may also be referred to as a body structure or chassis structure or the like. The vehicle frame 120 and associated components may have various designs and configurations, such as for different styles and types of vehicles. The vehicle structural components of the frame 120 may be formed of various materials, including predominately thin-walled metal structures, such as a beam component formed from a metal sheet, metal extrusion, stamping, molding, casting, or the like. For example, when formed from a metal sheet, the metal sheet material may comprise any metals or metal alloys that have the desired characteristics, such as stiffness, tensile strength, and the like. Also, the beam component material may include aluminum, magnesium, or steel, such as a high strength or ultra-high strength steel, as well as combinations of other related metals in different alloys. The metal sheet material may be formed in various processes, such as with the use of cold stamping, roll forming, roll stamping, hot stamping, press brake bending, or combinations thereof.

The reinforcement beam of the vehicle structural sensor may be integrated in or otherwise embodied as various types of structural components. The structural frame 120 shown in FIG. 1 includes a front-end structure having a bumper assembly 122 that has the structural sensor 102 embodied as a bumper beam spanning across the front end of the vehicle 110. As also shown in FIG. 1, the vehicle frame 120 includes rocker components 130 that extend longitudinally on outboard portions of the vehicle frame 120 between the front wheel area and the rear wheel area. The rocker components in some examples may be or otherwise include a structural sensor, such as shown in FIG. 31. The rocker components 130 are generally parallel to each other and crossmembers 132 (FIG. 31) may span laterally between the rocker components. In some examples, a center tunnel may be provided that extends longitudinally between the rocker components, such that the crossmembers may be divided by the tunnel. Also, in some examples, a battery tray may be provided below the floor of the vehicle and generally attached between or integrated between the rocker components. For purposes of this disclosure, the structural components of a vehicle battery tray or compartment may be considered a vehicle structural component. And further, such as shown in FIG. 1, a vehicle frame includes additional structural components, such as a rear bumper assembly 134, an A-pillar, a B-pillar, roof rails, door beams, and the like that may include a vehicle structural sensor or otherwise may be embodied as a structural sensor. In different types of vehicles, such as cars, trucks, and vans, the vehicle structure can vary substantially and include more or fewer and different types of structural components.

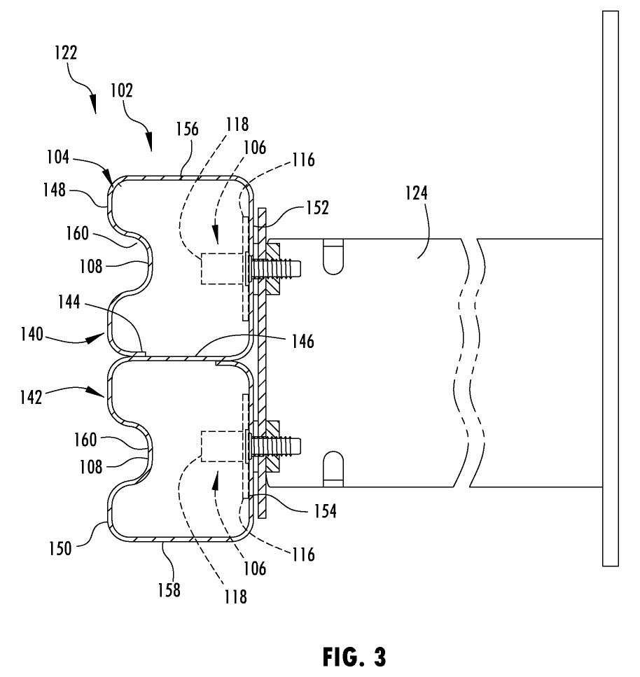

As shown in FIGS. 1 and 2, the reinforcement beam 104 of the structural sensor 102 may have a curved shape or sweep that is imparted along the length of the beam, which may generally conform the beam to the package space permitted by the vehicle design. The bumper assembly 122 shown in FIGS. 2 and 3 also includes crush cans 124 attached to a rear face of the bumper beam 104 near the lateral ends. The crush cans 124 are configured to support the reinforcement beam 104 and have a frangible structure designed to absorb certain impact loads. In some examples, the rear ends of the crush cans 124 may attach to a front rail 126 (FIG. 31) that extends rearward to couple with the mid-frame assembly, such as at or near a firewall 128. The front rails 126 may generally bracket a front engine compartment of the vehicle, although the vehicle may not include a propulsion system having an internal combustion engine, and so the front engine compartment may be a front storage compartment. In additional examples, the crush cans may be integrated into the front rails, and similarly, the extension brackets may be integrated into the bumper beam.

As shown in FIG. 3, the reinforcement beam 104 has an elongated hollow body defined by a thin-walled metal structure and having the inboard wall section 112 and the outboard wall section 114 extending between opposing ends of the reinforcement beam 104. The elongated hollow body includes a pair of tubular portions 140, 142 extending between opposing ends of the reinforcement beam 104. As shown in FIG. 3, the elongated hollow body is formed from a metal sheet having a seam defined by an edge section 144 of the metal sheet attached along an intermediate section of the metal sheet. The reinforcement beam 104 may be manufactured by roll forming a high-strength steel sheet, such as by uncoiling the sheet from a roll of sheet stock and roll forming the sheet to have a desired cross-sectional shape for efficiently absorbing impact energy, while minimizing the weight of the beam. The sheet may be continuously welded in the roll forming operation, such as via laser welding, to fix the formed sheet in the formed cross-sectional shape, such as with the closed tubular portions 140, 142. The beam 104 may be made from a sheet of steel material having a thickness of 0.8 mm to 1.5 mm or approximately between 1 mm and 1.4 mm. Also, the sheet may have a tensile strength of about 800 to 2000 MPa (i.e., about 120 to 290 ksi). In additional implementations, the reinforcement beam may be made of different materials, including Advanced High Strength Steel (AHSS), and may be formed from a sheet having a thickness of approximately 0.8 mm to 3.0 mm.

The reinforcement beam 104 shown in FIG. 3 is formed to have two adjacent tubular portions 140, 142 that share a common center wall 146 of the beam 104. The outer sections of the metal sheet that form the two adjacent tubular portions 140, 142 extend from opposing sides of a center section of the metal sheet that forms the common center wall 146 of the beam. Once the beam 104 is formed, the two adjacent tubular portions 140, 142 of the beam 104 are defined by front walls 148, 150, rear walls 152, 154, an upper wall 156, and a lower wall 158. The front walls 148, 150 of the adjacent tubular portions 140, 142 are substantially aligned with each other so as to form an outward-facing or impact surface of the beam and the corresponding bumper assembly 122. The front walls 148, 150 in the illustrated example each include a stiffening rib 160 that is about 8 mm to 10 mm deep and 8 mm to 10 mm wide, such as where the beam 104 is about 80 mm high and 40 mm deep. The rear walls 152, 154 are also in alignment with each other and are substantially parallel with the front walls 148, 150. Further, the upper and lower walls 156, 158 are substantially parallel with each other and the center wall 146 and generally perpendicular to the front and rear walls 148, 150, 152, 154. The radius of curvature at the corners between the walls of the beam 104 is between 3-4 mm, but may be greater in additional implementations, such as for sheet stock with a greater thickness. It is understood that additional examples of the beam may assume various cross-sectional shapes and orientations from that shown in FIG. 3 and may include alternative dimensional proportions, such as for different applications of the beam.

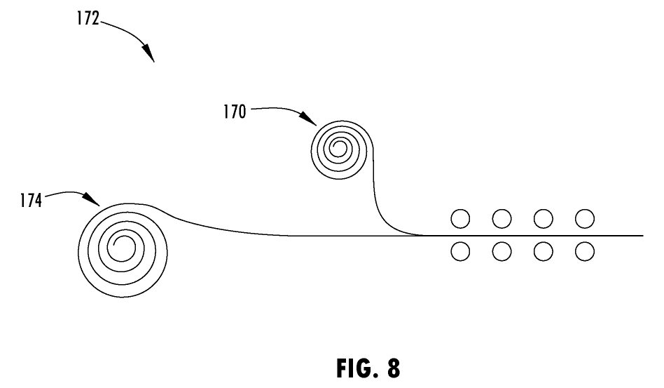

As also shown in FIG. 3, the flexible non-conductive substrate 116 of the vehicle structural sensor 102 is attached to the inboard wall section 112, which is shown as the rear walls 152, 154 of the illustrated reinforcement beam 104. The flexible non-conductive substrate 116 may be attached to the interior surface of the wall section with adhesive, fasteners, or other attachment means. The flexible non-conductive substrate 116 may include a bendable, non-electrically conductive material, such as a polyimide, polyester, other polymers, glass, rubber, or other materials or composites thereof. In some examples, the flexible non-conductive substrate may include a thin, flexible polymer strip configured to be unrolled from a coil 170 into the reinforcement beam, such as during a roll forming operation 172 where the beam is formed from a coiled metal sheet 174 (FIG. 8). Also, in some examples, the flexible non-conductive substrate includes a molded polymer strip, such that additional features or components may be molded into the polymer strip, such as the conductors or interconnected wires or the like.

The conductors 106 of the vehicle structural sensor 102, as shown in FIG. 3, are supported by the flexible non-conductive substrate 116. The conductors 106 each form a protrusion 118 that extends away from the flexible non-conductive substrate 116 toward the front walls 148, 150 of the reinforcement beam 104. The protrusions 118 shown in FIG. 3 are substantially rectangular and extend linearly, generally perpendicular to the rear walls 152, 154. As such, the protrusions 118 are suspended in the hollow interior of the tubular portions 140, 142 of the reinforcement beam 104 by being cantilevered from the rear walls 152, 154. The end portions of the protrusions 118 are spaced from the front walls 148, 150 at a set distance that does not cause arching or otherwise cause electrical contact in the suspended position. The set distance is also configured to cause electrical contact with the conductive portion 108 of the reinforcement beam 104 when the outboard wall section 114 deforms inward under the external impact force to the vehicle 110. The conductive portion 108 of the reinforcement beam 104 shown in FIG. 3 is defined by the inwardly protruding stiffening ribs 160. It is understood that the protrusions 118 may assume various geometries in different implementations, including loop shapes and spring structures.

As further shown in FIG. 3, the upper and lower tubular portions 140, 142 have differently sized protrusions 118, resulting in the shorter conductors 106 in the upper tubular portion 140 having a greater set distance of spacing between the end portion of the protrusion 118 and the conductive portion 108 than the set distance of spacing between the longer conductors 106 in the lower tubular portion 142. The different distances between the end portions of the protrusions 118 and the conductive portion 108 of the reinforcement beam 104 in the upper and lower tubular portions 140, 142 are configured to initiate contact to indicate a magnitude of impact force that corresponds to inboard intrusion distance resulting from the external impact force. In other words, the shorter intrusion distance at the lower tubular portion 142 indicates a smaller intrusion distance than the upper tubular portion 140.

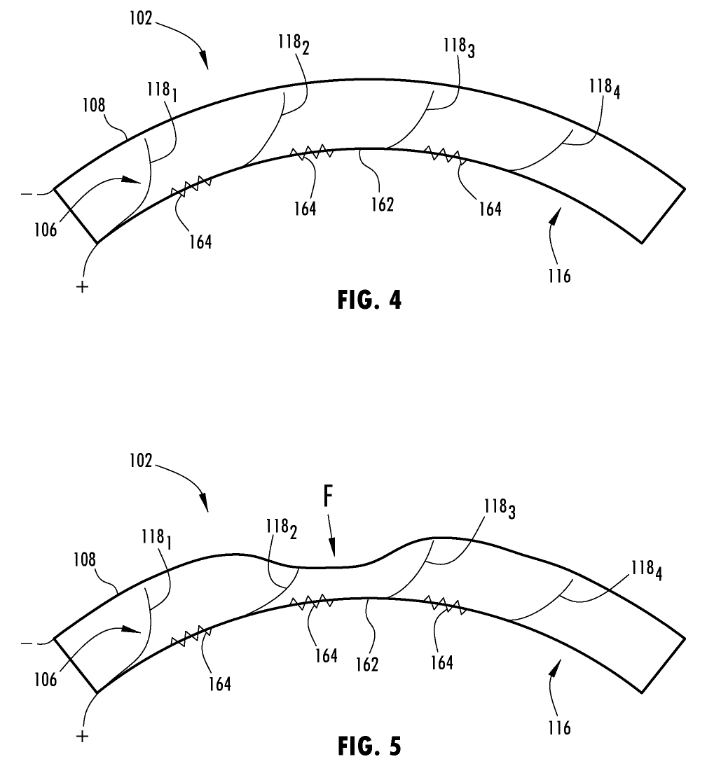

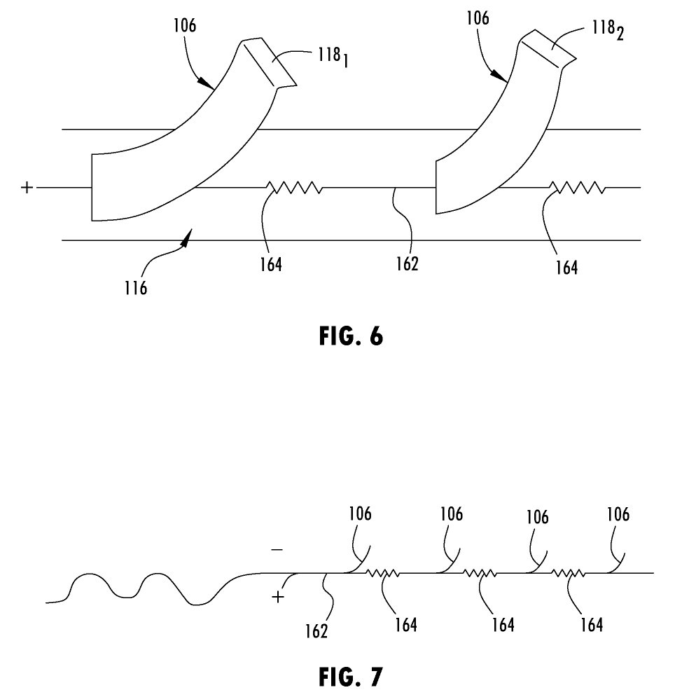

As shown schematically in FIGS. 4-7, the conductors 106 of the sensor 102 are electrically connected together and supported by the flexible non-conductive substrate 116. Each of the conductors 106 and their respective protrusions 118₁–118₄may be electrically connected together with a wire 162, such as in series as shown in FIG. 4. Also, at least one resistor 164 is electrically connected between each of the conductors 106, such that a system receiving signals from the vehicle structural sensor 102 may be configured to compare the sensed resistance in order to determine the location of the impact F along the length of the sensor 102 and the corresponding electrical contact along the length of the reinforcement beam.

As shown in FIG. 5, the impact F deforms the conductive portion 108 inward to contact the end of the second protrusion 118₂. The resulting electrical contact forms a circuit with a current that has a resistance that corresponds to one resistor 164, which is indicative of the impact location at the second protrusion 118₂. With impacts at different locations, a resistance without a resistor would indicate the location of the first protrusion 118₁, a resistance with two resistors 164 would indicate the location of the third protrusion 118₃, and a resistance with three resistors 164 would indicate the location of the fourth protrusion 1184. The resistance value resulting from the electrical contact at a given conductor 106 is communicated as a signal to the controller 101, which is configured to compare the sensed resistance to known resistance values corresponding to the respective protrusion locations, thereby determining the location of the impact along the length of the reinforcement beam. It is also contemplated that additional circuit designs may be used in other examples to provide an indication of the impact location.

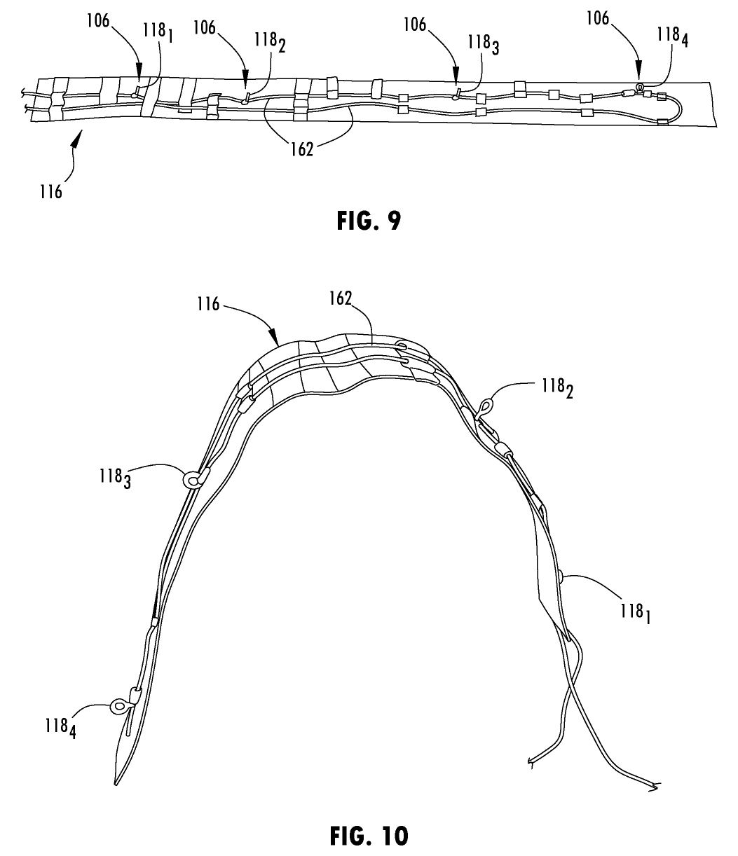

As similarly shown in FIGS. 9 and 10, an additional example of the flexible non-conductive substrate 116 supports the conductors 106 and the wire 162 connecting the conductors 106. The conductors 106 each form a protrusion 118 that extends away from the flexible non-conductive substrate 116 in a loop shape to be suspended in a hollow interior of a reinforcement beam. The flexible non-conductive substrate 116 is a thin, flexible polymer strip that also supports the wire 162 that connects the conductors 106. The wire 162 shown in FIGS. 9 and 10 forms a loop so that the electrical connection to the vehicle system can be made on a single end of the corresponding reinforcement beam.

As shown in FIGS. 11-13, another example of a vehicle structural sensor 202 shows a linear reinforcement beam 204 and a set of conductors 206 supported by a non-conductive substrate 216 defining a semi-rigid carrier, which may together be referred to as a conductor module. The semi-rigid carrier forming the non-conductive substrate 216 is arranged or otherwise inserted into a hollow interior of the reinforcement beam 204 to locate the conductors at spaced locations along the length of the section of the reinforcement beam 204 occupied by the non-conductive substrate 216. The elongated hollow body of the reinforcement beam 204 includes a pair of tubular portions 240, 242 extending between opposing ends of the reinforcement beam 204. As shown in FIG. 11, the elongated hollow body has the closed tubular portions 240, 242 divided by a common center wall 246.

In the example shown in FIGS. 11-13, the conductors 206 are configured to make electrical contact with conductive portions 208 when the outboard wall section 214 of the beam 204 deforms inward under an external impact force to the vehicle. The conductive portions 208 in the example shown in FIGS. 11-13 are separate from the structure of the beam 204, and instead are integrated with the semi-rigid carrier forming the non-conductive substrate 216. By the coupling of the rigid carrier to the reinforcement beam 204, the conductive portions 208 are directly adjacent to the reinforcement beam 204 and may be located in direct or indirect contact with the interior surface of the reinforcement beam 204. As such, the elongated body of the reinforcement beam may be coated with a non-electrically conductive material, such as paint or a galvanized coating, where the conductive portions on the rigid carrier form the conductive portions of the beam that contact the conductors upon receiving an impact force that deforms the reinforcement beam 204 a threshold distance of intrusion (FIG. 13). With the conductors supported by a rigid carrier, the conductive portions in other examples may still be part of the structure of the reinforcement beam.

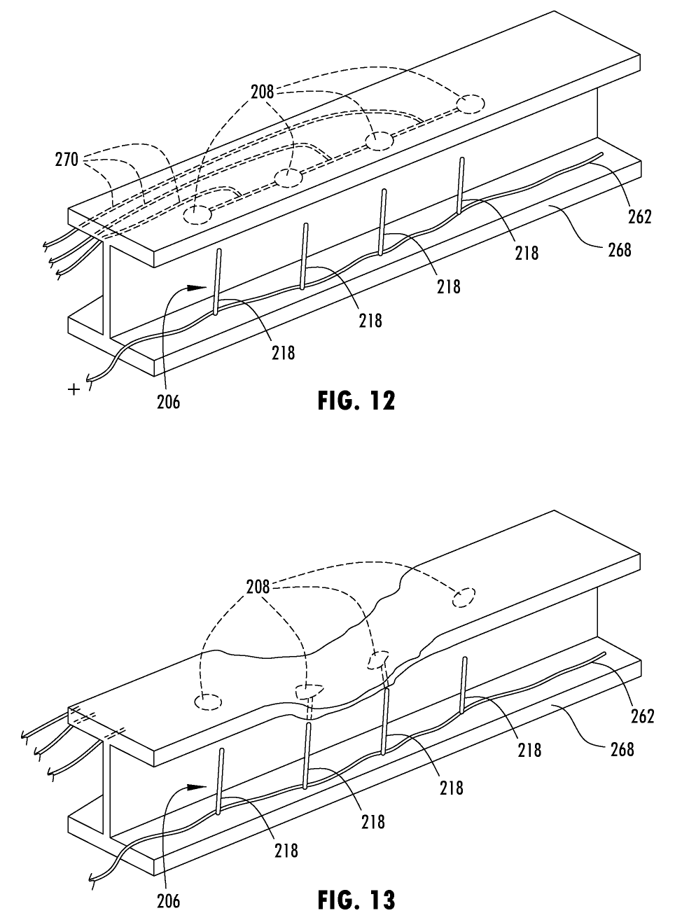

As further shown in FIG. 12, the semi-rigid carrier forming the non-conductive substrate 216 has an I-shaped cross-section defining a first side portion 266 that supports the conductors 206 and a second side portion 268 that supports the conductive portions 208 or contacts. The conductors 206 are electrically connected together with a wire 262 and each form a protrusion 218 that extends away from the flexible non-conductive substrate 216 toward the conductive contacts 208 supported by the first side portion 266 of the rigid carrier. The first side portion 266 of the rigid carrier may also include traces or wires 270 that are molded in or otherwise attached to the rigid structure of the non-conductive substrate 216. The center leg 272 of the rigid carrier separates the first and second side portions 266, 268, such that the end portions of the protrusions 218 are spaced from the conductive contacts 208 in a manner that is configured to cause electrical contact when the outboard wall section of the reinforcement beam deforms inward under an external impact force to the vehicle.

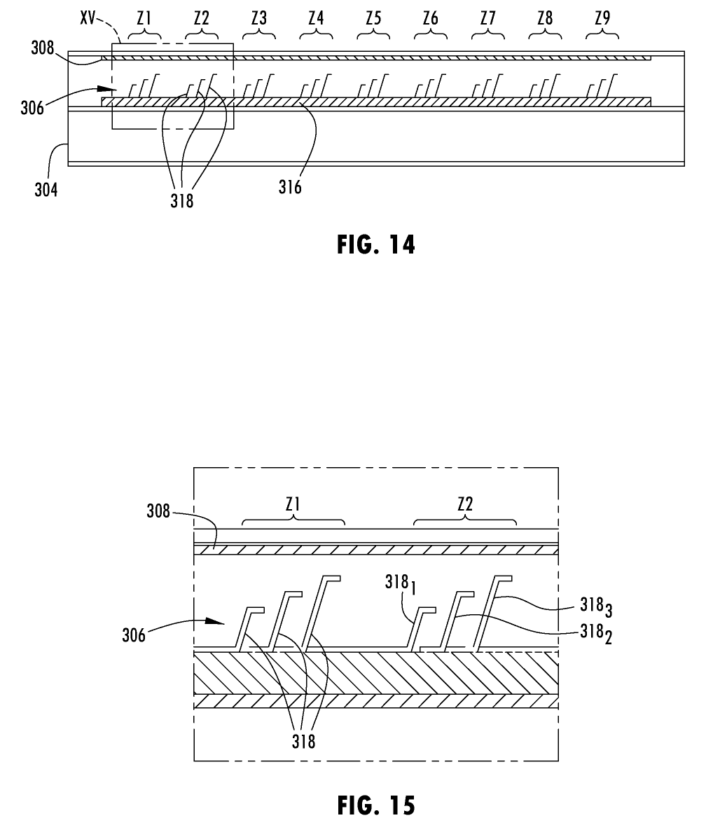

In the example shown in FIGS. 14 and 15, the conductors 306 are supported on a single carrier 316 and may include individual conductor protrusions 318 extending at different distances. As shown in FIG. 14, these conductor protrusions 318 extend toward a single conductive portion 308 that may be integrated or otherwise attached to the reinforcement beam 304 with adhesive or the like. The protrusions 318 extend generally parallel to each other at different distances from the flexible non-conductive substrate 316, where the different distances are configured to determine a corresponding intrusion distance and a location of the impact along the length of the reinforcement beam 304. As shown in FIG. 14, the conductors 306 are grouped into sensor zones Z1-Z9 spaced along the length of the reinforcement beam 304, with each of the plurality of zones having conductors 306 extending at least two different distances from the flexible non-conductive substrate 316 to be configured to determine a corresponding intrusion distance of the impact. The grouped zones of conductors 306 also are configured to determine a location of the impact along the length of the reinforcement beam 304. As shown in FIG. 15, a first conductor 318₁extends from the flexible non-conductive substrate a first distance, a second conductor 318₂extends from the flexible non-conductive substrate a second distance longer than the first distance, and a third conductor 318₃extends from the flexible non-conductive substrate a third distance longer than the second distance. The three distances may be configured to indicate a magnitude of impact force that corresponds to inboard intrusion distance resulting from the external impact force. In other words, the impact can cause deformation to different intrusion distances, which can be determined by the different length conductors.

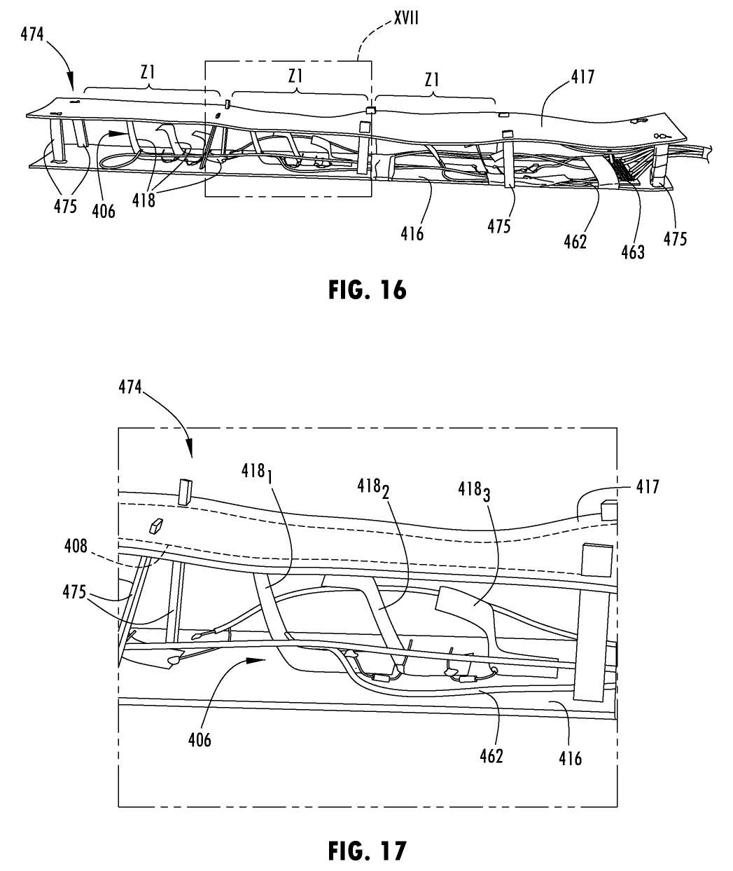

As shown in FIGS. 16 and 17, a flexible non-conductive substrate 416 supporting conductors 406 is assembled as a conductor module 474 with the conductive portion 408 supported on a secondary substrate 417. As such, the flexible non-conductive substrate 416 may be referred to as a primary substrate. The conductor module 474 is configured to be inserted into a reinforcement beam, such as along a hollow interior of a tubular portion thereof, for monitoring deflection and deformation of the beam. In the inserted position, the secondary substrate 417 is adjacent to and interfaces with the structure of the reinforcement beam. When the conductor module 474 is installed within the reinforcement beam, the secondary substrate 417 is positioned adjacent to the outboard wall section and the flexible non-conductive substrate 416 is positioned adjacent to the inboard wall section, such that the functional relationship between the conductors, the conductive portion, and the wall sections corresponds to that described above with respect to the non-module embodiments.

The flexible non-conductive substrate 416 and the secondary substrate 417 define planar members that are separated by stanchions 475. The stanchions 475 are non-conductive spacer elements that maintain a fixed separation distance between the flexible non-conductive substrate 416 and the secondary substrate 417. This fixed separation distance defines the set distance between the end portions of the protrusions 418 and the conductive portion 408, and is selected to correspond to a desired deformation threshold for initiating electrical contact upon impact. As shown in FIGS. 16 and 17, the flexible non-conductive substrate 416 and the secondary substrate 417 are rubber belts, where the conductive portion 408 is a metal strip attached along the length of the interior surface of the rubber belt. In additional examples, the conductive portion may be separate metal contacts and the substrates may be other non-conductive materials and structures that are sufficiently flexible to be inserted into and conform to the corresponding shape of a reinforcement beam.

The fixed separation distance defined by the stanchions 475 is selected based on the structural properties and expected deformation behavior of the corresponding reinforcement beam, such that the set distance corresponds to a deformation threshold above which structural damage to the reinforcement beam is considered to have occurred. The fixed separation distance may be varied along the length of the conductor module to provide different deformation thresholds at different locations along the length of the reinforcement beam, such as to correspond to different structural zones or expected deformation profiles of the reinforcement beam.

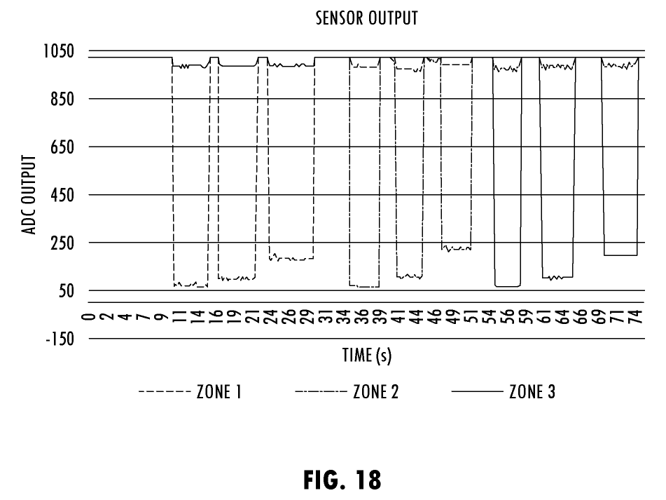

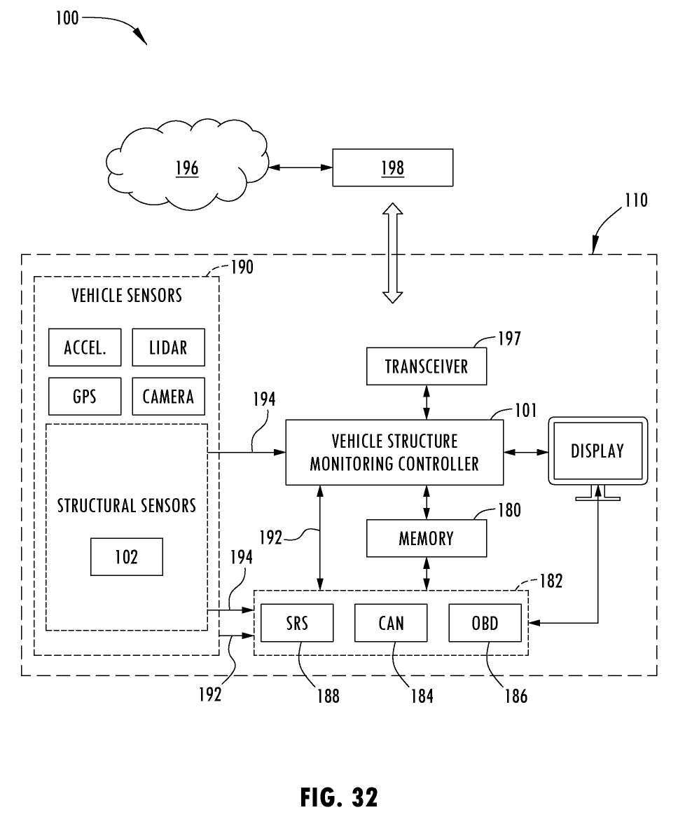

As further shown in FIGS. 16 and 17, opposite the conductive portion 408, the interior surface of the flexible non-conductive substrate 416 supports the conductors 406, which are grouped into sensor zones Z1-Z3. The sensor zones are configured to be spaced along the length of the corresponding reinforcement beam. Each of the conductors 406 and their respective protrusions 418₁–418₃are electrically connected together with wires 462 that may extend to and connect at a circuit board 463, which may connect to a controller or other vehicle system (FIGS. 31 and 32). The grouped zones of conductors 406 are configured to determine a location of the impact along the length of the corresponding reinforcement beam. Similar to FIGS. 14 and 15, each of the zones Z1-Z3 have three protrusions shown as a first conductor 418₁that extends from the flexible non-conductive substrate 416 a first distance, a second conductor 418₂that extends from the flexible non-conductive substrate 416 a second distance longer than the first distance, and a third conductor 4183 that extends from the flexible non-conductive substrate 416 a third distance longer than the second distance. As shown in FIG. 18, the three conductors 418₁-418₃and the corresponding spaced distances from the conductive portion 408 are configured to indicate a magnitude of impact force that corresponds to inboard intrusion distance resulting from the external impact force. Specifically, the sensor output provides a progressively higher ADC output when contact is made with the first, the second, and the third conductors 418₁-418₃. Accordingly, the impact can cause deformation to different intrusion distances, which can be determined by the different length conductors.

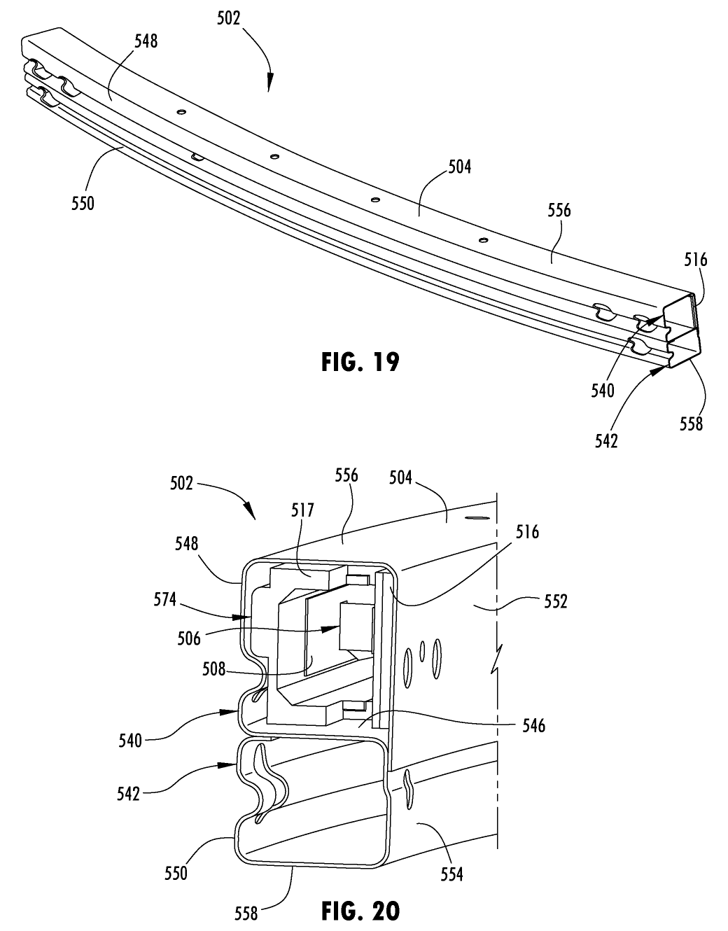

Referring to FIGS. 19-22, an additional example of a vehicle structural sensor 502 is shown having a conductor module 574 that is provided on an interior of a reinforcement beam 504 that may be used as a bumper beam of a bumper assembly. The conductor module 574 is configured to be inserted into a reinforcement beam for monitoring deflection and deformation of the reinforcement beam 504. The conductor module 574 similarly includes conductors 506 suspended away from a conductive portion 508 that are supported respectively on opposing substrates 516, 517. The beam 504 shown in FIGS. 19 and 20 is formed from a metal sheet to have two adjacent tubular portions 540, 542 that share a common center wall 546 of the beam 504. The two adjacent tubular portions 540, 542 of the beam 504 are defined by front walls 548, 550, rear walls 552, 554, an upper wall 556, and a lower wall 558. The conductor module 574 is inserted into the upper tubular portion 540, such as by sliding the assembled conductor module 574 into the formed upper tubular portion 540 along the length and in the insert direction shown in FIG. 19. Alternatively, in other examples, the conductor module or portions thereof may be formed or assembled into the beam during its formation.

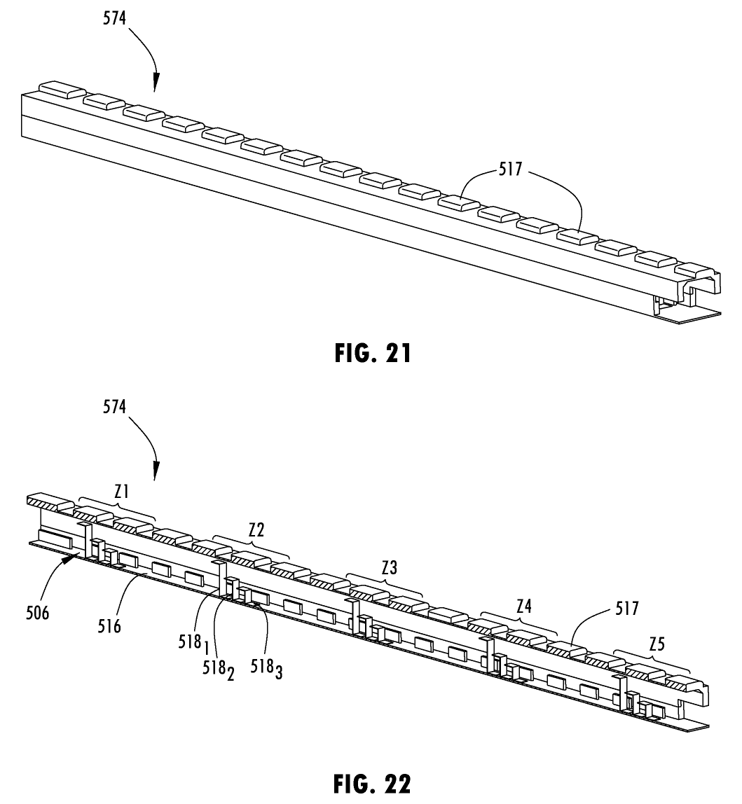

As shown in FIGS. 21 and 22, the conductor module 574 is illustrated outside of the reinforcement beam 504 (FIG. 20). The conductor module 574 has the primary substrate or flexible non-conductive substrate 516 and the secondary substrate 517, each forming an elongated channel member that are attached together to define an elongated flexible casing that has open ends to form a hollow tubular shape. The outer profile of the casing formed by the flexible non-conductive substrate 516 and the secondary substrate 517 is generally sized and shaped to conform to the interior profile of the corresponding tubular portion 540 of the beam 504. The flexible non-conductive substrate 516 and the secondary substrate 517 may be molded, printed, or otherwise formed from various materials, and preferably non-conductive materials, such as one or more polymers, a thermoplastic elastomer (e.g., thermoplastic polyurethane), a thermosetting polymer, rubber, polyurethane, polystyrene, fiberglass, cellulose, or the like, and combinations thereof.

With continued reference to FIGS. 21 and 22, the conductive portion 508 (FIG. 20) is a metal strip attached along the length of the interior surface of the secondary substrate 517. Opposite the conductive portion 508, the interior surface of the flexible non-conductive substrate 516 supports the conductors 506, which may be spaced along the length of the beam and may be grouped into sensor zones Z1-Z5. The sensor zones are configured to be spaced along the length of the corresponding reinforcement beam 504 (FIG. 20). Each of the conductors 506 and their respective protrusions 518₁–518₃are electrically connected together and may connect to a controller or other vehicle system (FIGS. 31 and 32). The grouped zones of conductors 506 are configured to determine a location of the impact along the length of the corresponding reinforcement beam. Also, each of the zones Z1-Z5 has three protrusions shown as a first conductor 518₁that extends from the flexible non-conductive substrate 516 a first distance, a second conductor 518₂that extends from the flexible non-conductive substrate 516 a second distance longer than the first distance, and a third conductor 518₃that extends from the flexible non-conductive substrate 516 a third distance longer than the second distance.

The protrusions forming the conductors 506 shown in FIG. 22 each have a metal strip formed in a series of alternating bends to define a Z-shape, adding robustness to each protrusion and effectively forming a spring structure. In additional examples, the metal strip may be differently formed, such as an arc shape or an accordion shape or the like. Each of the conductors 506 and their respective protrusions 518₁–518₃are electrically connected together with wires that may extend to and connect at a circuit board, which may connect to a controller or other vehicle system (FIGS. 31 and 32).

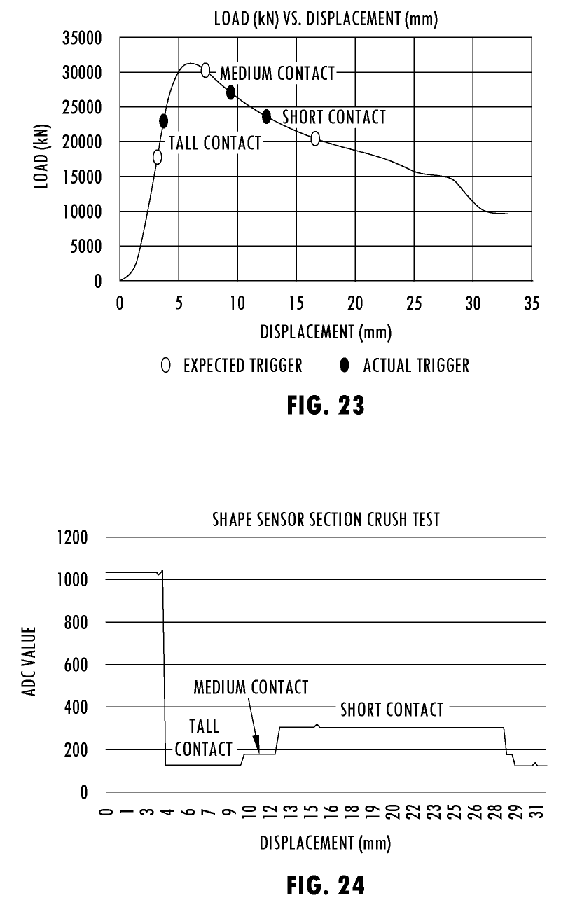

With reference to FIGS. 22 and 23, the three conductors 5181-518₃and the corresponding spaced distances from the conductive portion 508 (FIG. 20) are configured to indicate a magnitude of impact force that corresponds to inboard intrusion distance resulting from the external impact force. As a load is applied, displacement of the bumper beam 504 results, and corresponding contact is made at the respective protrusions 518₁–518₃. Also, as shown in FIG. 24, the sensor output provides a progressively higher ADC output when contact is made with the first, the second, and the third conductors 518₁-518₃. This demonstrates the effectiveness of the vehicle structural sensor to sense the deformation and resulting intrusion distance, as well as the expected magnitude of force for the corresponding sensed deformation.

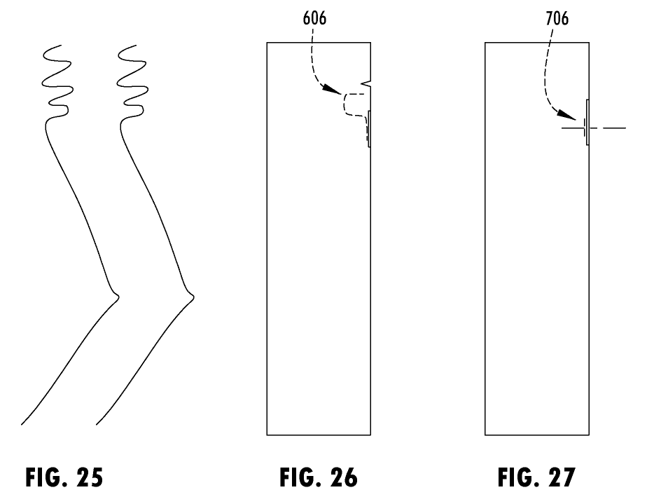

Furthermore, as shown in FIGS. 25-27, another implementation shows a front rail of a vehicle being deformed under axial loading, where the beam can predictably deform at specific locations along the length, such as at or near bend initiator features. Accordingly, the conductors can be located on the reinforcement beam of the front rail for the end portion of a protrusion to contact a conductive portion of the front rail that bends toward the end portion under axial loading. As shown in FIG. 26, the hook-shaped conductor 706 is configured to contact the bend in the reinforcement beam adjacent to the conductor. The hook-shaped conductor 706 is cantilevered from an interior wall of the front rail beam and is positioned adjacent to a predicted deformation zone of the front rail beam. The hook shape of the conductor 706 is configured to intercept and contact the inwardly bending wall of the front rail beam as the beam deforms under axial loading, thereby forming an electrical contact that indicates deformation at that location. Similarly, as shown in FIG. 27, the conductor 806 is configured to contact a conductive portion that is located on the opposing side of a slit or crush initiator, where the slit or crush initiator closes upon axial loading of the front rail to make the electrical contact. The conductor 806 is positioned on one side of a slit or crush initiator formed in the wall of the front rail beam, with a conductive portion located on the opposing side of the slit or crush initiator. The slit or crush initiator closes upon axial loading of the front rail beam, bringing the conductor 806 into electrical contact with the conductive portion and thereby indicating the initiation of crushing deformation at that location.

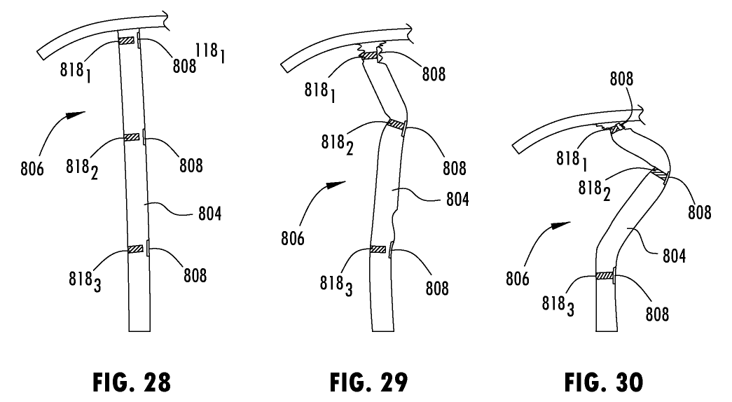

In a further implementation of the front rail embodiment of the vehicle structural sensor 906, as shown in FIGS. 28-30, a set of conductors 918₁-918₃are located along the length of the front rail beam 904 at specific locations that are configured to predictably deform upon receiving a front impact. The protrusions or conductors 918₁-918₃extend laterally within the hollow interior of the front rail beam 904 by being suspended or cantilevered from a side wall of the front rail beam. The protrusions or conductors 918₁-918₃are spaced from the opposing side walls at a set distance that does not arch or otherwise cause electrical contact in the suspended position. The opposing side wall supports the conductive portions 908, which, as shown in FIGS. 28-30, are defined by individual conductive pieces positioned or otherwise attached to the interior surface of the beam. The set spaced distance is also configured to cause electrical contact with the conductive portion 908 when the front rail 904 deforms and bends under the external impact force to the front bumper beam, as progressively shown in FIGS. 29 and 30. With the predicted deformation of the front rail beam, the first conductor 918₁nearest the bumper beam may make initial contact with the conductive portion 908, the second conductor 918₂second nearest the bumper beam may make contact second with the conductive portion 908, and the third conductor 918₃furthest from the bumper beam may make contact with the conductive portion 908 last in sequence, such that the location and likely points of failure or deformation can be sensed and the resulting impact force can be estimated by the controller.

The sequential contact of the first, second, and third conductors 918₁–918₃with the respective conductive portions 908 provides a corresponding sequence of local deformation signals to the controller 101. The controller 101 is configured to determine from the sequence and timing of these signals both the progressive location of deformation along the length of the front rail beam 904 and an estimate of the magnitude of the impact force based on the number of conductors that have made contact and the deformation simulation data stored in the memory unit 180 for the front rail beam 904.

Referring now to FIGS. 31 and 32, a controller 101 in electrical communication with the structural sensor 102 integrated with the bumper assembly 122 and other vehicle components with integrated conductors 106, so as to provide additional vehicle structural sensors. When the signal from the vehicle structural sensor is above a threshold, it indicates a degree of deformation, such that the controller 101 can determine a structure condition value and output the structure condition value to a memory unit 180 (FIG. 32), where the memory unit may be accessed by a user to monitor the structural condition of the vehicle structural components. By using deformation simulation data for the structural component, the location that is prone to failure can be selected for locating the structural sensor. Moreover, each structural component having a structural sensor can be analyzed to determine its failure conditions and deformation behavior, which is generally referred to as its failure modes, such as bending or cracking modes at certain locations on the component and at certain impact forces.

As shown in FIGS. 31 and 32, the controller 101 comprises a processor and a memory unit 180 for storing instructions that, when executed by the processor, cause the controller 101 to perform the functions described herein. The memory or memory unit 180 may store threshold condition values, including the repair threshold and the occupant safety threshold, as well as historic deformation data and structural health records for each monitored vehicle structural component. The memory unit 180 may be integrated with the controller 101 or separate.

Referring again to FIG. 31, the structural sensors 102 are shown electrically connected to the controller 101, which may be wired connections or wireless connections. The controller 101 is configured to electronically receive signals from the structural sensors 102. As shown in FIG. 32, the vehicle 110 has an internal communication network 182 that interconnects electronic systems within the vehicle 110. The network 182 may have certain protocols, such as a Controller Area Network (CAN) 184, and other communication requirements for vehicle control on the network, such as to assure accurate and speedy communication on the network. As such, it can be beneficial to minimize demands on the network 182. The network 182 may also have a connector for an On-Board Diagnostics (OBD) 186 and a Supplemental Restraint System (SRS) 188. The supplemental restraint system 188 may use other vehicle sensors 190, such as accelerometers to aid in the detection of a collision event. These auxiliary vehicle sensors 190 may also include GPS, LIDAR, and cameras, among other on-board sensors that may provide data to the internal communications network 182 and the data 192 may be shared by the vehicle structure monitoring controller 101 and the system memory unit 180. The controller 101 may access data 192 through the internal communications network 182. However, a network is not required for the system 100 to function. The structural sensors 102 may be independent from other systems and the controller 101 may directly receive the signals 194 from one or more structural sensors 102.

The controller 101 is configured to receive the local signal 194 from at least one of the structural sensors 102. When the local signal 194 is above a threshold, it indicates a degree of deformation to the corresponding location on the vehicle structural component. Based on the local signal 194, the controller 101 determines a structure condition value and outputs the structure condition value to a memory unit 180. The memory unit 180 may also be accessed by the onboard network 182, such that the memory unit 180 may be accessed by a user to monitor the structural condition and historic impact data of the vehicle structural components.

As shown in FIG. 31, the vehicle structure monitoring system 100 may include a plurality of vehicle structural sensors 102 disposed at multiple structural locations on the vehicle 110, including the front bumper assembly 122, the front rails 126, the rocker components 130, the rear bumper assembly 134, and other structural components. The controller 101 is configured to receive respective local deformation signals from each of the plurality of structural sensors 102 and to determine a respective structure condition value for each structural sensor 102, thereby providing structural health data for a plurality of discrete structural locations on the vehicle simultaneously and over time.

The controller 101 may also receive a collision signal from an auxiliary vehicle sensor 190, such as via the SRS 188, that indicates an impact with an object has occurred. In response to the collision signal, the controller 101 can receive the local deformation signal 194 from the structural sensor 102 to confirm or validate the detected collision with one or more of the auxiliary vehicle sensors 190.

The controller 101 may determine whether the structure condition value exceeds a threshold condition value to generate a notification when the component condition value exceeds the threshold condition value. The threshold condition value may include a repair threshold or an occupant safety threshold. The threshold condition values, including the repair threshold and the occupant safety threshold, may be stored in the memory unit 180 and may be established based on deformation simulation data for the corresponding structural component, prior test data, regulatory requirements, or a combination thereof. As such, the notification may identify the threshold condition value that has been exceeded. The notification may be a signal to a display or remotely to a server or external network 196, which may be accessed by a remote receiver 198, such as a satellite or cell tower network. The remote receiver 198 may be within a portable electronic device, such as a cellular phone, satellite phone, or tablet, and the remote receiver 198 may be connected to and accessible via the internet. The remote receiver 198 may receive the local deformation signal 194, the structure condition value, the component condition value, and/or any other generated message or graphic, and may actively notify a user outside of the vehicle 110, such as a first responder network or repair professional. The remote receiver 198 may also provide access to information pertaining to the potential damage of the vehicle 110.

The system 100 may include a transceiver 197 and the controller 101 may be in communication with the transceiver 197 and capable of sending the structure condition value and associated local deformation signal from the vehicle using the transceiver. The transceiver 197 may be configured to send the data via methods such as a cellular network or radio frequency broadcast, as represented by the remote receiver 198.

As further shown in FIG. 32, the controller 101 may be programmed to output a message to the display based on the structure condition value. The display may also include a user interface, such as a capacitive touch screen, that allows inputs by the user to access the structure condition value and historic impact data on the system 100. The display, such as a vehicle display, a mobile device, or a remote display, may display an image showing the structure condition value and the prior structure condition value.

The controller 101 may also send the sensed or generated data, such as the local deformation signal 194, the structure condition value, the component condition value, and/or any other generated message or graphic to the memory unit 180. The stored data may include the corresponding data from the vehicle sensors with a time stamp to be accessed at a later time. For example, the corresponding data may include GPS data, or the like, providing location information of the vehicle 110 at the time of a collision. The data may be accessed from the memory unit 180 directly through a separate tool and/or the network 182, such as the connector to the OBD, as indicated by arrows.

The processes, methods, or algorithms disclosed herein can be delivered to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

It is also contemplated that the structure of the disclosed components may be incorporated in other types of structural beams or components, such as in frames and structures of automotive and marine vehicles and the like. The vehicle components disclosed herein may be incorporated with various applications of different structural components. The vehicle component may be designed to support and sustain different loading conditions, such as for supporting certain horizontal spans or axial loading conditions. Also, the vehicle component may be designed to undergo various impact forces, such as for the illustrated front impacts, as well as side or rear impacts. The cross-sectional geometry, material type selections, and material thickness within the cross-sectional profile of the vehicle component may be configured for such a particular use and the desired loading and performance characteristics, such as the weight, load capacity of the beam, force deflection performance, and impact performance of the vehicle component.

For purposes of this disclosure, the articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote one element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present disclosure, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A vehicle structural sensor comprising:
a reinforcement beam having an inboard wall section and an outboard wall section, the outboard wall section configured to deform inward toward the inboard wall section upon receiving an external impact force, the reinforcement beam having a conductive portion on an interior surface of the inboard wall section or the outboard wall section;
a flexible non-conductive substrate attached to an interior surface of the inboard wall section or the outboard wall section of the reinforcement beam; and
a plurality of conductors electrically connected together and supported by the flexible non-conductive substrate,
wherein the plurality of conductors each form a protrusion that extends away from the flexible non-conductive substrate toward an opposing interior surface of the inboard wall section or the outboard wall section, and
wherein end portions of the protrusions are spaced from the opposing interior surface at a set distance configured to cause electrical contact with the conductive portion when the outboard wall section deforms inward under the external impact force.

2. The vehicle structural sensor of claim 1, wherein a resistor is electrically connected in series between each adjacent pair of the plurality of conductors, such that a resistance value sensed across the plurality of conductors corresponds to a location of electrical contact along a length of the reinforcement beam.

3. The vehicle structural sensor of claim 1, wherein the plurality of conductors includes a first conductor extending from the flexible non-conductive substrate a first distance and a second conductor extending from the flexible non-conductive substrate a second distance greater than the first distance, and wherein the first and second distances are configured such that electrical contact at the first conductor indicates a first depth of inward deformation of the outboard wall section and electrical contact at the second conductor indicates a second, greater depth of inward deformation corresponding to a greater magnitude of external impact force.

4. The vehicle structural sensor of claim 3, wherein the plurality of conductors are divided into a plurality of sensor zones spaced along a length of the reinforcement beam, and wherein each sensor zone comprises at least the first conductor and the second conductor extending at the first and second distances, respectively, such that electrical contact within a given sensor zone indicates both a depth of inward deformation and a location of impact along the length of the reinforcement beam.

5. The vehicle structural sensor of claim 1, wherein the flexible non-conductive substrate comprises at least one of a polyimide, polyester, glass, rubber, or polymer composite.

6. The vehicle structural sensor of claim 1, wherein the reinforcement beam has an elongated hollow body having the inboard and outboard wall sections extending between opposing ends of the reinforcement beam.

7. The vehicle structural sensor of claim 6, wherein the plurality of conductors is disposed along the interior surface of the elongated hollow body at an intermediate section of the elongated hollow body between the opposing ends.

8. The vehicle structural sensor of claim 6, wherein the elongated hollow body comprises a pair of tubular portions extending between the opposing ends of the reinforcement beam.

9. The vehicle structural sensor of claim 6, wherein the elongated hollow body is formed from a metal sheet having a seam defined by an edge section of the metal sheet attached along an intermediate section of the metal sheet, and wherein the elongated hollow beam is one of a bumper beam, a frame component, a door beam, or a rocker component.

10. A vehicle structural sensor comprising:
a reinforcement beam having an inboard wall section and an outboard wall section, the outboard wall section configured to deform inward toward the inboard wall section upon receiving an external impact force; and
a conductor module disposed within a hollow interior of the reinforcement beam, the conductor module comprising:
a flexible non-conductive substrate disposed along an interior surface of the inboard wall section; and
a plurality of conductors supported by the substrate, each conductor forming a protrusion that extends from the substrate toward a conductive portion disposed at or integrated with an interior surface of the outboard wall section,
wherein the protrusions are spaced from the conductive portion at a set distance and configured to cause electrical contact with the conductive portion when the outboard wall section deforms inward under the external impact force.

11. The vehicle structural sensor of claim 10, further comprising:
a secondary substrate disposed opposite the substrate along the interior surface of the outboard wall section, the secondary substrate having the conductive portion on an interior surface thereof.

12. The vehicle structural sensor of claim 11, wherein the conductive portion comprises a metal strip attached along a length of the interior surface of the secondary substrate.

13. The vehicle structural sensor of claim 11, further comprising:
a plurality of non-conductive stanchions separating the substrate from the secondary substrate at a fixed separation distance.

14. The vehicle structural sensor of claim 10, wherein a resistor is electrically connected in series between each adjacent pair of the plurality of conductors such that a resistance value sensed across the plurality of conductors corresponds to a location of electrical contact along a length of the reinforcement beam.

15. The vehicle structural sensor of claim 14, wherein the plurality of conductors includes a first conductor extending from the flexible non-conductive substrate a first distance and a second conductor extending from the flexible non-conductive substrate a second distance.

16. The vehicle structural sensor of claim 10, wherein the plurality of conductors are divided into a plurality of sensor zones spaced along a length of the reinforcement beam, each sensor zone comprising a first conductor extending from the substrate a first distance, a second conductor extending from the substrate a second distance greater than the first distance, and a third conductor extending from the substrate a third distance greater than the second distance, such that sequential electrical contact at the first, second, and third conductors indicates a progressively greater depth of inward deformation of the reinforcement beam.

17. The vehicle structural sensor of claim 16, wherein the reinforcement beam has an elongated hollow body having the inboard and outboard wall sections extending between opposing ends of the reinforcement beam, and wherein the elongated hollow body is formed from a metal sheet having a seam defined by an edge section of the metal sheet attached along an intermediate section of the metal sheet.

18. A vehicle structural monitoring system comprising:
a vehicle structural sensor comprising a reinforcement beam having an inboard wall section and an outboard wall section configured to deform inward toward the inboard wall section upon receiving an external impact force, the reinforcement beam having a conductive portion on an interior surface thereof;
a flexible non-conductive substrate attached to an interior surface of the inboard wall section or the outboard wall section;
a plurality of conductors electrically connected together and supported by the flexible non-conductive substrate, each conductor forming a protrusion that extends toward an opposing interior surface of the reinforcement beam, wherein end portions of the protrusions are spaced from the opposing interior surface at a set distance configured to cause electrical contact with the conductive portion when the outboard wall section deforms inward under the external impact force; and
a controller in electrical communication with the vehicle structural sensor, the controller configured to:
receive a local deformation signal from at least one of the plurality of conductors indicating electrical contact above a threshold that corresponds to a degree of inward deformation of the reinforcement beam;
determine a structure condition value based on the local deformation signal;
determine whether the structure condition value exceeds a threshold condition value; and
generate a notification when the structure condition value exceeds the threshold condition value.

19. The vehicle structural monitoring system of claim 18, wherein the threshold condition value comprises at least one of a repair threshold or an occupant safety threshold, and wherein the notification is transmitted to at least one of a vehicle display, a memory unit onboard the vehicle, or a remote receiver via a transceiver.

20. The vehicle structural monitoring system of claim 18, wherein the controller is further configured to receive a collision signal from an auxiliary vehicle sensor indicating that an impact with an object has occurred, and in response to the collision signal, receive the local deformation signal from the vehicle structural sensor to confirm or validate a detected collision.
